(19) United States
(12) Patent Application Publication
(10) Pub. No.: US 2012/0079770 A1
(43) Pub. Date: Apr. 5, 2012

(54) PULLING KNOB, PUSHING KNOB, AND HINGED DOOR HAVING THE SAME

(76) Inventor: Dong Gil Kevin Yoo, Seoul (KR)

(21) Appl. No.: 12/863,820

(22) PCT Filed: Jun. 23, 2009
(86) PCT No.: PCT/KR2009/003351

§ 371 Date: Jul. 21, 2010

(51) Int. Cl. E05B 1/00; E06B 3/34

(52) U.S. Cl. 49/381; 16/414

(57) ABSTRACT

A pulling knob for a hinged door, mounted to a door surface of a hinged door, includes an upper post and a lower post respectively mounted to the door surface at one ends thereof, and a first grip portion and a second grip portion respectively extending from the other ends of the upper and lower posts, the first and second grip portions being tilted toward the door surface and connected with each other. A pushing knob includes a pad body, which has a base surface mounted to the door surface and a pad surface formed at an opposite side of the base surface and having a tilted structure in one direction. A hinged door includes the pulling knob and the pushing knob.

### TECHNICAL FIELD

The present invention relates to a knob of a hinged door, and a hinged door having the same. In more detail, the present invention relates to a pulling knob and a pushing knob, configured to regulate a hinged door to be opened in one direction, and a hinged door having the same.

Generally, a hinged door is installed to a frame of an exit at its one edge by a hinge so as to be opened by pushing or pulling a knob. After being opened, the hinged door is automatically closed due to a restoring force of a predetermined elastic device coupled to the hinge.

The hinged door is pivoted on the hinge when being opened or closed. Thus, if users located in and out of the exit pull or push the knobs in opposite directions together, the hinged door is substantially not pivoted, so the hinged door may not be opened.

In fact, at a hinged door used as a bi-direction door in public facilities such as government offices and banks, the above problem occurs frequently since a lot of persons pass through the hinged door.

Some hinged doors have notices attached at interior and exterior door surfaces thereof so as to guide passengers to push or pull the hinged door, but passengers seldom check the notice while opening or closing the hinged door due to busy and congested circumstances.

As an alternative, a stopper may be installed to prohibit a pivotal movement of the hinged door in one direction such that the hinged door may be opened only in one direction, namely inwards or outwards. However, if such a stopper is installed at the hinged door, when a user pushes a knob of the hinged door in a prohibited direction, the door keeps its fixed state against the user's will, so the user may be confused or feel inconvenience. Even in a serious case, the force applied from the user to the knob may be inversely influenced back to the user to give an excessive stress to the joint or muscle of the user, which may hurt the user.

### DISCLOSURE OF INVENTION

### Technical Problem

The present invention is designed to solve the problems of the prior art, and therefore it is an object of the present invention to provide a pulling knob and a pushing knob of a hinged door, which have ergonomic structures for regulating the hinged door to be 1 opened in one direction and also allowing a user to recognize an opening direction of the hinged door by intuition and give a force properly. The present invention is also directed to providing a hinged door having the same.

### Technical Solution

In order to accomplish the above object, the present invention provides a knob for a hinged door, which is mounted to a door surface of a hinged door and serves as a pulling knob, the knob including an upper post and a lower post respectively mounted to the door surface at one ends thereof; and a first grip portion and a second grip portion respectively extending from the other ends of the upper and lower posts, the first and second grip portions being tilted toward the door surface and connected with each other.

Preferably, the upper and lower posts have a rod structure perpendicular to the door surface.

Also preferably, an angle between the first and second grip portions is 90° to 120°.

The first and second grip portions may have a rod structure integrally formed with the first and second posts, and the knob may further include a buffer pad partially surrounding the first and second grip portions.

Preferably, the buffer pad or the first and second grip portions may have guide grooves for placing fingers of a human body therein.

In another aspect of the present invention, there is also provided a knob for a hinged door, which is mounted to a door surface of a hinged door and serves as a pushing knob, wherein the knob includes a pad body, which has a base surface mounted to the door surface and a pad surface formed at an opposite side of the base surface and having a tilted structure in one direction.

Preferably, a depressed portion corresponding to a hand shape of a human body is formed in the pad surface of the pad body.

This knob may further include an advertisement formed on the depressed portion.

In still another aspect of the present invention, there is also provided a hinged door, which includes a door body, and a pulling knob, which includes upper and lower posts respectively mounted to the door surface at one ends thereof, first and second grip portions respectively extending from the other ends of the upper and lower posts, the first and second grip portions being tilted toward the door surface and connected with each other.

Preferably, the pulling knob has a rod structure perpendicular to the door surface.

Also preferably, an angle between the first and second grip portions is 90° to 120°.

The hinged door may further include a pushing knob mounted to the other surface of the door body, the pushing knob having a pad surface titled to be spaced apart from the surface of the door body in a downward direction.

Preferably, a depressed portion corresponding to a hand shape of a human body is formed in the surface of the pushing knob, and the depressed portion has a depth gradually decreased in a downward direction of the door body.

In further another aspect of the present invention, there is also provided a hinged door, which includes a door body, and a pushing knob having a base surface mounted to the door surface and a pad surface formed at an opposite side of the base surface and having a tilted structure to be spaced apart from the surface of the door body in a downward direction.

### Advantageous Effects

The knobs for a hinged door according to the present invention has an ergonomic structure such that a user may push or pull the knobs in a natural and convenient way, so a user may recognize an opening direction of the hinged door by intuition and operate the hinged door properly.

Thus, it may solve the problem that users in and out of the exit pull or push the hinged door in opposite directions at the same time. In this way, the knobs of the present invention may give convenience to users while preventing any accident.

### BRIEF DESCRIPTION OF DRAWINGS

Other objects and aspects of the present invention will become apparent from the following description of embodiments with reference to the accompanying drawing in which:

FIG. 1 is a perspective view showing a pulling knob according to a preferred embodiment of the present invention;

FIG. 2 is a side view showing a hinged door provided with the pulling knob according to a preferred embodiment;

FIG. 3 is a perspective view showing an appearance of a pushing pad provided according to a preferred embodiment of the present invention;

FIG. 4 is a side view showing a hinged door provided with a pulling knob and a pushing knob according to a preferred embodiment of the present invention; and

FIG. 5 is a side view illustrating how the hinged door according to a preferred embodiment is operated.

### REFERENCE NUMERALS OF ESSENTIAL PARTS IN THE DRAWINGS

100: upper post
101: lower post
102a: first grip portion
102b: second grip portion
103: buffer pad
105, 105′: guide groove
200: pushing knob
201a: base surface
201b: pad surface
202: depressed portion

### BEST MODE FOR CARRYING OUT THE INVENTION

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

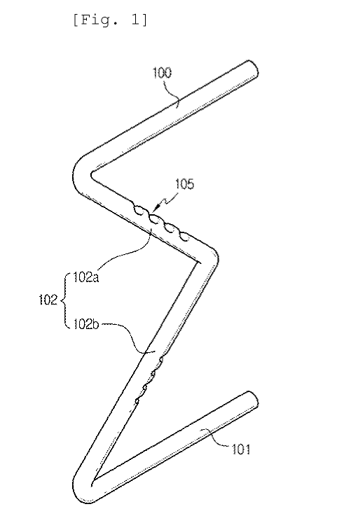

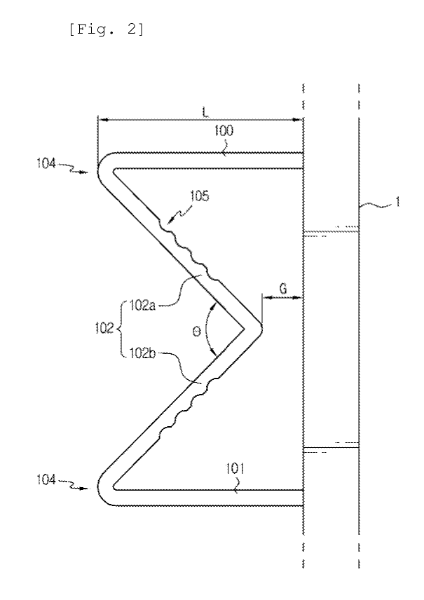

FIGS. 1 and 2 shows a pulling knob and a hinged door having the same according to a preferred embodiment of the present invention.

Referring to FIGS. 1 and 2, a pulling knob of the present invention includes an upper post 100 and a lower post 101, mounted to one side of a door body 1, and a grip 102 provided between the upper post 100 and the lower post 101.

The upper post 100 and the lower post 101 are respectively mounted to a door surface of the door body 1 at their one ends to play a role of supporting the body of the pulling knob. The upper post 100 and the lower post 101 preferably have a rod structure perpendicular to the door surface, but they may also have a ribbon structure, not limited thereto. Also, the upper post 100 and the lower post 101 preferably have a linear shape, but they may also have a curved shape, not limited thereto.

Though not shown in the figure, a common bolt-nut structure may be adopted to mount one ends of the upper post 100 and the lower post 101 to the door body 1, and various kinds of coupling means may also be used. For better coupling, a predetermined flange or bracket may be additionally fixed to ends of the upper post 100 and the lower post 101, mounted to the door body 1.

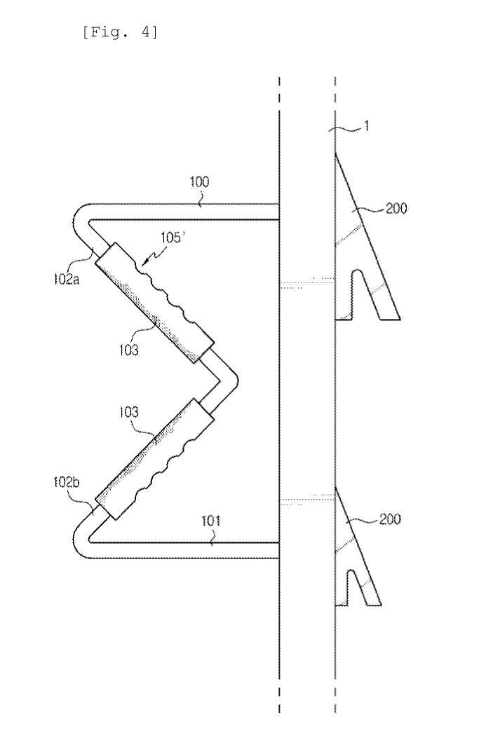

The grip 102 includes a first grip portion 102a and a second grip portion 102b, respectively extending from the other ends of the upper post 100 and the lower post 101. Similarly to the upper post 100 and the lower post 101, the grip 102 preferably has a rod structure or a ribbon structure. Also preferably, the grip 102 is integrally formed with the upper post 100 and the lower post 101 by means of injection molding or bending. In order to protect the hand of a user who grasps the grip, a buffer pad 103 (see FIG. 4) made of sponge or decorating sheet is preferably provided to surround some portions of the upper post 100 and the lower post 101.

The first grip portion 102a and the second grip portion 102b extends toward the door surface while being tilted, and they are connected each other. Since the first grip portion 102a and the second grip portion 102b are tilted toward the door surface, the wrist of a user is slightly bent upwards or downwards while the hand of the user grasps the corresponding grip, so the pulling motion may be made naturally in aspect of the structure of a human body. However, in such a state, the pushing motion is unnatural and does not give a sufficient force toward the door. Meanwhile, since the upper and lower posts 100, 101 extends in opposite directions of the first and second grip portions 102a, 102b, a protrusion 104 sharply protruding substantially toward a user is formed at a portion where the upper or lower post 100, 101 is connected with the grip 102. The protrusion 104 naturally arouses unwelcome attention against pushing motion, thereby inducing a user to pull the pulling knob.

Thus, when manipulating the pulling knob, a user takes an action of pulling the pulling knob toward his/her body by intuition while grasping the first or second grip portion 102a, 102b. In order to induce such a user action more efficiently, the upper and lower posts 100, 101 are preferably designed to have a length L of 20 cm or less, and an angle (θ) between the first and second grip portions 102a, 102b is preferably designed as 90° to 120°. These numerical ranges have threshold meanings in aspect of ergonomics since the titled structure of the first and second grip portions 102a, 102b and their protrusions are remarkable in the above ranges, and the wrist of a user is naturally bent in the above ranges not to exert excessive force when the user grasps and pulls the grip 102.

A portion where the first and second grip portions 102a, 102b are connected with each other preferably has a gap G of 4 cm or more from the door surface so as to prevent any accident at that portion such as jamming of a finger.

Also, guide grooves 105 are preferably formed in the first and second grip portions 102a, 102b such that fingers of a human body are placed therein. The guide grooves 105 induce a user to grasp and pull the first and second grip portions 102a, 102b by intuition, and also the guide grooves 105 help fingers of a user to be closely adhered to the first and second grip portions 102a, 102b in a convenient way when the user grasps the grip. In case the buffer pad 103 is provided to the first and second grip portions 102a, 102b, guide grooves 105′ are preferably formed in the buffer pad 103.

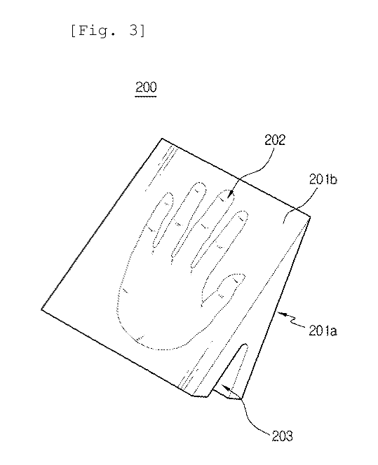

The hinged door of the present invention may be further provided with a pushing knob 200 as shown in FIG. 3. The pushing knob 200 is used for a user to push and open the hinged door. The pushing knob 200 includes a pad body, which has a base surface 201a substantially processed flat so as to be mounted to the hinged door, and a pad surface 201b prepared at an opposite side of the base surface 201a and having a tilted structure in one direction.

As shown in FIG. 4, the pushing knob 200 is configured such that the base surface 201a is mounted to the other side of the door body 1, and the pad surface 201b is inclined so as to be gradually spaced apart from the surface of the door body 1 in a downward direction of the door body 1. In aspect of the structure of a human body, a lower portion of the palm is located closer to the human body than an upper portion of the palm when a user pushes the hinged door. Thus, the inclined structure of the pad surface of the pushing knob 200, inclined to be closer to the body of a user in a downward direction of the door body 1, is well matching with the human body.

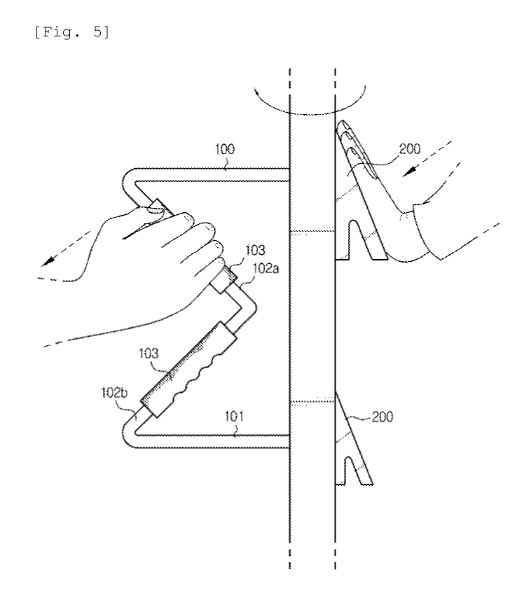

When manipulating the pushing knob, a user places his/her palm on the surface of the pushing knob 200 by intuition and then takes an action for applying a force toward the door body 1 and thus pushing the hinged door. To allow a user to make such an action easily, the pushing knob 200 should be installed at a suitable height in consideration of the height of a user. In this point of view, it is preferred that two pushing knobs 200 are installed in upper and lower portions of the door body 1 for adults and children, as shown in FIG. 5.

A depressed portion 202 corresponding to a hand shape is preferably formed in the surface of the pushing knob 200 so as to induce a pushing action of the user. The depressed portion 202 of the pushing knob 200 attracts user's eyes. Thus, if an advertisement (not shown) is provided to the depressed portion 202, an effective advertising function may be obtained. Here, the depressed portion 202 preferably has a depth gradually decreased in a downward direction of the door body 1 such that water or im-purities may be easily discharged downwards.

Additionally, a concave portion 203 defining a predetermined cavity is prepared at a lower end of the pad body of the pushing knob 200 such that a user may put his/her fingers therein. The concave portion 203 allows a user to put fingers therein and then temporarily pull the pushing knob 200, when required.

FIG. 5 illustrates an operating state of the hinged door according to the preferred embodiment of the present invention. As shown in FIG. 5, the hinged door according to the preferred embodiment of the present invention is configured such that the pulling knob is mounted to one side of the door body 1 and the pushing knob 200 is mounted to the other side of the door body 1. In FIG. 5, the door body 1 is regulated to be opened only in a left direction. Thus, a user located in a left side based on the door body 1 may recognize by intuition from the tilted structure of the grip 102 and the protrusion 104 formed at the pulling knob that he/she should pull the pulling knob, so the user then grasps any one of the first and second grip portions 102a, 102b and takes a pulling action to open the hinged door.

Meanwhile, a user located in a right side based on the door body 1 may recognize by intuition from the depressed portion 202 of a hand shape and the tilted structure of the pushing knob 200 tilted toward the user's body in a downward direction that he/she should push the pushing knob 200, so the user then places the palm on the depressed portion 202 of the pushing knob 200 and applies a force toward the door body 1 to take a pushing action, thereby opening the hinged door.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

1-6. (canceled)

7. A knob for a hinged door, which is mounted to a door surface of a hinged door and serves as a pushing knob, wherein the knob comprises a pad body, which has a base surface mounted to the door surface and a pad surface formed at an opposite side of the base surface and having a tilted structure in one direction.

8. The knob for a hinged door according to claim 7, wherein a depressed portion corresponding to a hand shape of a human body is formed in the pad surface of the pad body.

9. The knob for a hinged door according to claim 8, further comprising an advertisement formed on the depressed portion.

10-13. (canceled)

14. A hinged door, comprising:
a door body; and
a pushing knob having a base surface mounted to the door surface and a pad surface formed at an opposite side of the base surface and having a tilted structure to be spaced apart from the surface of the door body in a downward direction.

15. The hinged door according to claim 14, wherein a depressed portion corresponding to a hand shape of a human body is formed in the surface of the pushing knob, and wherein the depressed portion has a depth gradually decreased in a downward direction of the door body.

16. The hinged door according to claim 15, further comprising an advertisement formed on the depressed portion.

17. The hinged door according to claim 14, further comprising:
a pulling knob which is mounted to a opposite door surface opposite to the door surface which the pushing knob is mounted, the pulling knob comprising:
an upper post and a lower post respectively mounted to the door surface at one ends thereof; and
a first grip portion and a second grip portion respectively extending from the other ends of the upper and lower posts, the first and second grip portions being tilted toward the door surface and connected with each other.

18. The hinged door according to claim 17, wherein the upper and lower posts have a rod structure perpendicular to the door surface.

19. The hinged door according to claim 18, wherein an angle between the first and second grip portions is 90° to 120°.

20. The hinged door according to claim 19, wherein the first and second grip portions have a rod structure integrally formed with the first and second posts, and wherein the knob further comprises a buffer pad partially surrounding the first and second grip portions.

21. The hinged door according to claim 20, wherein the buffer pad has guide grooves for placing fingers of a human body therein.

22. The hinged door according to claim 17, wherein the first and second grip portions have guide grooves for placing fingers of a human body therein.
